(19) United States
(12) Patent Application Publication
(10) Pub. No.: US 2007/0287117 A1
(43) Pub. Date: Dec. 13, 2007

(54) Flexible windproof candleholder

(76) Inventor: Cheng-Chung Chang, Hemel Township (TW)

Correspondence Address: TROXELL LAW OFFICE PLLC, SUITE 1404, 5205 LEESBURG PIKE, FALLS CHURCH, VA, 22041, US

(21) Appl. No.: 11/449,713

(22) Filed: Jun. 9, 2006

(51) Int. Cl. F23N 5/00; F23Q 25/00; F21V 35/00; F21S 8/00; F21L 19/00; F21S 13/00; F23D 3/16

(52) U.S. Cl. 431/296; 362/161; 362/162; 362/163; 362/180; 431/33; 431/144; 431/148; 431/151

(57) ABSTRACT

One flexible windproof candleholder, which is composed of upper-open cylinder candleholder with gap at its side to change candle, a slide cover that covers onto periphery of candleholder and canister cover with light holes that covers onto interior of candleholder; wherein protruding stopper ball is respectively set at external and internal rim of bottom section of candleholder; concave parts made at lower rim of slide cover and canister cover can be used for block, so, slide cover moves down to envelop gap, wind may not blow candle; as slide cover and canister cover respectively move down to periphery and interior of candleholder, slide cover is pushed against upper cover of canister cover so that internal space of candleholder is sealed, the burning candle may extinguish itself due to lack of oxygen, canister cover slides upward along vertical runner setting in symmetry inside candleholder by stopper ball protruded at external low section, meanwhile, slide cover also slides upward to upper section of candleholder, you can change candle easily because gap is not enveloped at this moment, therefore, such candleholder is safe and convenient in application.

### BACKGROUND OF THE INVENTION

1) Field of the Invention

This invention relates to one flexible windproof candleholder, which is to apply closed cylinder slide cover and canister cover with light holes on surface to cover onto periphery and interior of candleholder. Basing on stopper ball and vertical runner or concave part, canister cover can slide up/down, slide and canister cover get blocked each other, so that such flexible candleholder can resist wind or extinguish itself.

2) Description of the Prior Art

Usually, the common “candleholder” is to hold candle so that light of candle creates a gentle and romantic environment. It is one of the most popular decorative goods at home or in public occasion; however, candleholder applied at present cannot provide any shelter for burning candle, so, it is easy to be put out by wind. If above said occasion occurred several times, it might bring with inconvenience and trouble, moreover, the extinguished candle may produce choked smoke due to the said incomplete burning, which may pollute the environment around; therefore, it is necessary to improve such candleholder.

### SUMMARY OF THE INVENTION

1. Problems to Solve:

(1) No matter candle is placed on candleholder completely or partially open, the burning candle may be often put out if the blowing wind is strong enough, because candleholder cannot provide any shelter to it.

(2) Furthermore, candle standing on this candleholder may also be put out by heavy breathing air or spitting saliva and spraying liquid drinks, so, it is inconvenient for daily use.

(3) Candle standing on the common candleholder is often puffed out directly, and the choked smoke due to incomplete burning may flee hither and thither because such candleholder doesn't provide any shelter, so, you may feel discomfort.

2. Solutions:

A. The flexible windproof candleholder of this invention is to apply closed cylinder slide cover and canister cover with light holes on surface to cover onto periphery and interior of candleholder. Basing on stopper ball and vertical runner or concave part, canister cover can slide up/down, slide and canister cover get blocked each other, so that such flexible candleholder can resist wind or extinguish itself.

B. Canister cover can slide up/down by the vertical runner, so that it may not displace and get blocked properly, light of candle emitted may not be disturbed.

C. When slide and canister cover respectively move down to periphery and interior of candleholder, slide cover is pushed against upper cover of canister cover so that internal space of candleholder is sealed, the burning candle may extinguish itself due to lack of oxygen, the choked smoke from incomplete burning may not flee hither and thither.

### BRIEF DESCRIPTION OF THE DRAWINGS

FIG. 1 is the exploded view of structure of this invention.

FIG. 2 is the exploded combination and application sketch map of structure of this invention.

FIG. 3 is the exploded view of this invention in complete open state.

FIG. 4 is the detailed map of this invention in complete open state.

FIG. 5 is the detailed map of this invention in complete closed state.

FIG. 6 is the sketch map of this invention to change candle.

### DETAILED DESCRIPTION OF THE PREFERRED EMBODIMENTS

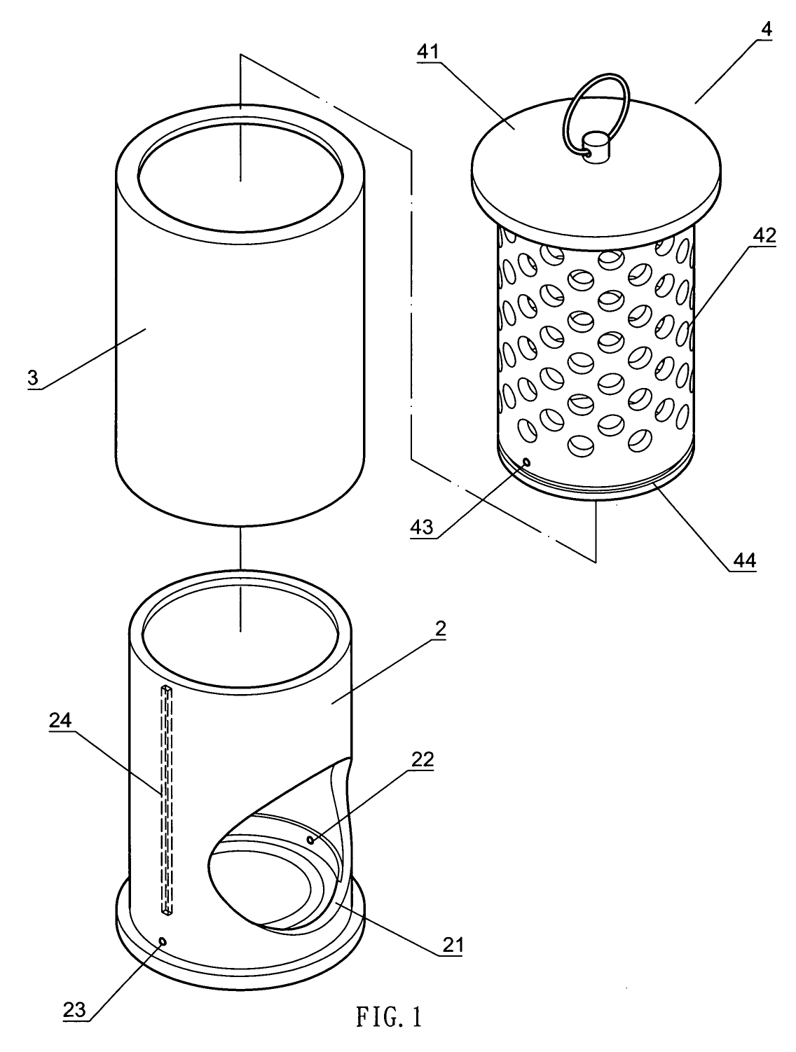

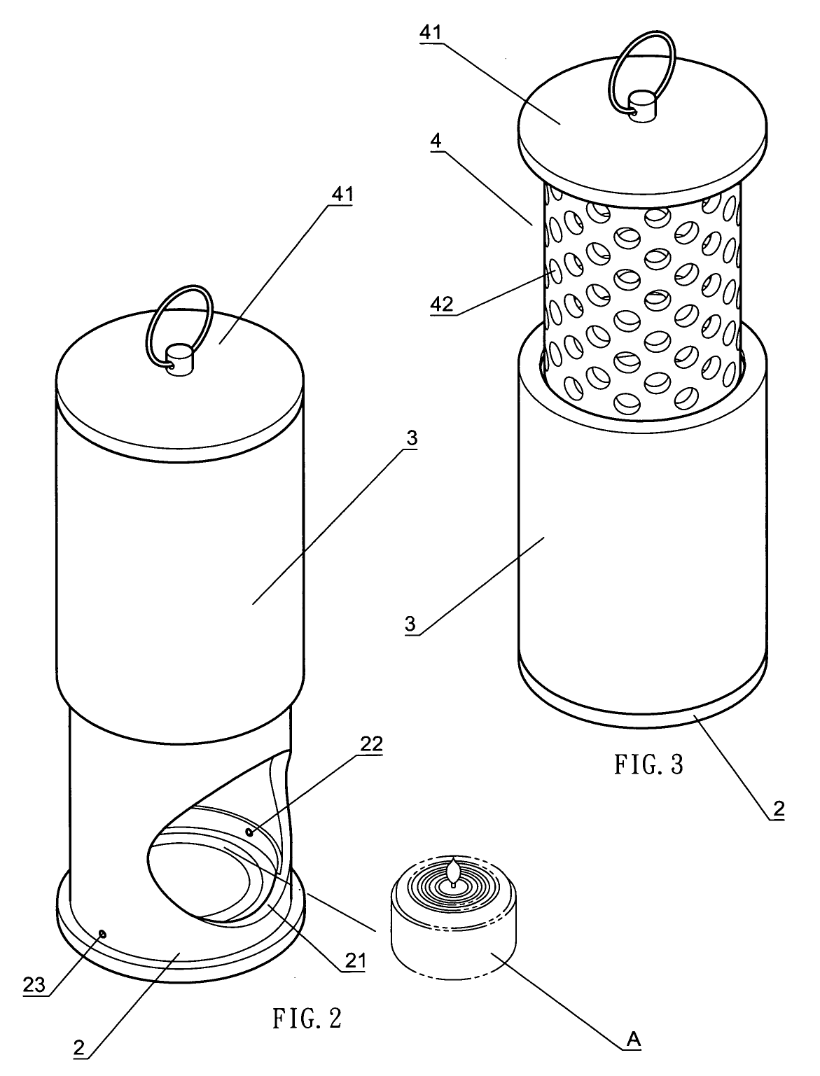

First of all, please refer to FIG. 1 and FIG. 2, this invention is composed of candleholder 2, slide cover 3 and canister cover 4; wherein

Candleholder 2 is an upper-open cylinder with gap 21 to change candle A, protruding stopper ball 22 and 23 are respectively set at internal and external rims of its bottom, vertical runner 24 is also set in it;

Slide cover 3 is a hollow cylinder, concave part 31 matching to stopper ball 22 is set at its lower rim;

Canister cover 4 is a bottom-open canister, its top is upper cover 41 in larger diameter, light holes 42 are equally distributed over canister, and stopper ball 43 is set at lower section of canister's external rim, concave part 44 matching to stopper ball 23 is also set at its lower rim;

Thus, slide cover 3 covers onto periphery of candleholder 2 and canister cover 4 covers onto interior of candleholder 2, windproof candleholder is assembled accordingly(refer to FIG. 2).

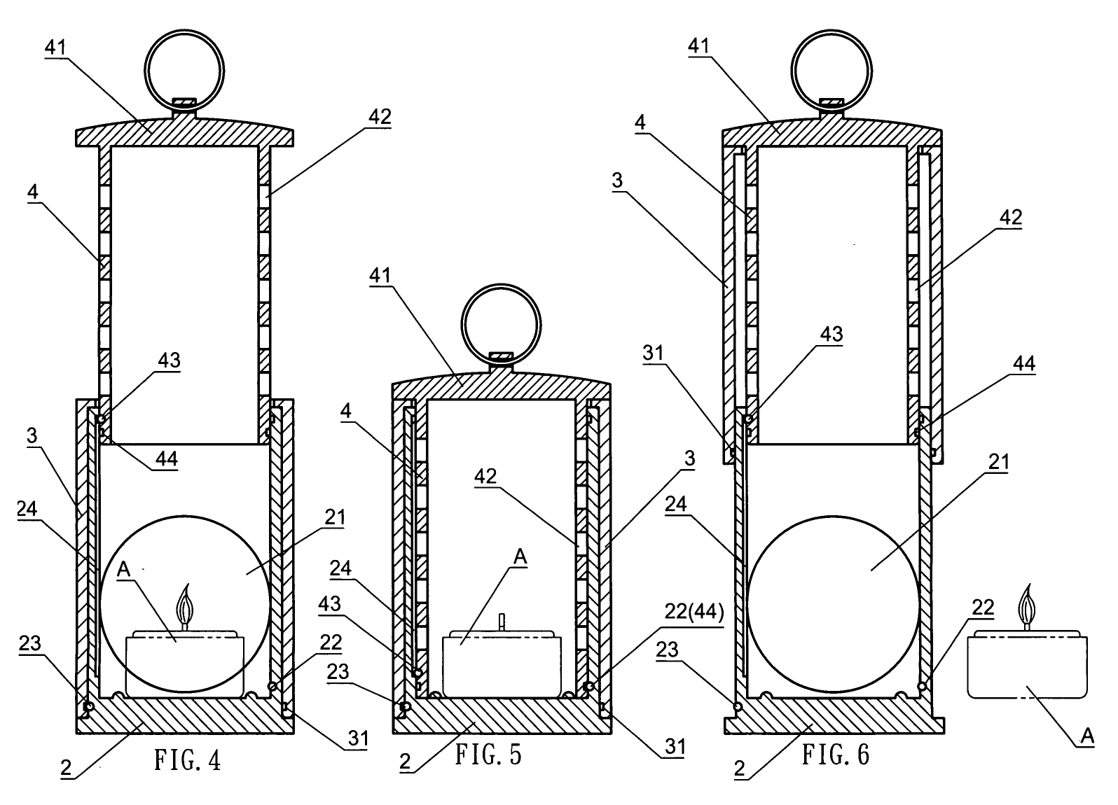

Furthermore, please refer to FIG. 3, FIG. 4, FIG. 5 and FIG. 6, as slide cover 3 moves down to envelop gap 21, wind may not blow candle A, then, canister cover 4 covers onto candleholder 2, it can be blocked at top of vertical runner 24 by stopper 43, the ignited candle A can emit light through light hole 42 over canister cover 4 (see FIG. 3 and FIG. 4) ; when slide cover 3 and canister cover 4 respectively move down to periphery and interior of candleholder 2, slide cover 3 is pushed against upper cover of canister cover 4 so that internal space of candleholder 2 is sealed, the burning candle may extinguish itself due to lack of oxygen (refer to FIG. 5), canister cover 4 slides upward along vertical runner 24 setting in symmetry inside candleholder 2 by stopper ball protruded at external low section, meanwhile, slide cover also slides upward to upper section of candleholder 2, you can change candle A easily because gap 21 is not enveloped at this moment(see FIG. 6 for detail). Therefore, such candleholder is safe and convenient in application.

To sum up above descriptions, candleholder of this invention is not only convenient to pack up and bring with, but also can block wind and extinguish itself, it is obvious that it has qualified for new patent.

What is claimed is:

1. One flexible windproof candleholder, which is composed of upper-open cylinder candleholder with gap at its side to change candle, a slide cover that covers onto periphery of candleholder and canister cover with light holes that covers onto interior of candleholder; wherein protruding stopper ball is respectively set at external and internal rim of bottom section of candleholder; concave parts made at lower rim of slide cover and canister cover can be used for block, so, slide cover moves down to envelop gap, wind may not blow candle; as slide cover and canister cover respectively move down to periphery and interior of candleholder, slide cover is pushed against upper cover of canister cover so that internal space of candleholder is sealed, the burning candle may extinguish itself due to lack of oxygen, canister cover slides upward along vertical runner setting in symmetry inside candleholder by stopper ball protruded at external low section, meanwhile, slide cover also slides upward to upper section of candleholder, you can change candle easily because gap is not enveloped at this moment. Therefore, such candleholder is safe and convenient in application.

2. As claimed in claim 1, it is flexible windproof candleholder, wherein stopper ball in this structure is combined with elastomer and ball, which is applicable to elastic buckle.
